(19) United States
(12) Patent Application Publication
(10) Pub. No.: US 2016/0277155 A1
(43) Pub. Date: Sep. 22, 2016

(54) EFFICIENT RESOURCE ALLOCATION FOR ACKNOWLEDGEMENT/NON-ACKNOWLEDGEMENT PHYSICAL UPLINK SHARED CHANNEL AND PERIODIC CHANNEL STATE INFORMATION PHYSICAL UPLINK SHARED CHANNEL

(71) Applicant: NOKIA TECHNOLOGIES OY, Espoo (FI)

(72) Inventor: Mauri NISSILÄ, Oulu (FI)

(21) Appl. No.: 14/660,513

(22) Filed: Mar. 17, 2015

(51) Int. Cl. H04L 1/18; H04B 7/06; H04L 27/26; H04W 56/00; H04W 72/04

(52) U.S. Cl. CPC H04L 1/1812; H04W 56/001; H04W 72/0406; H04L 27/2662; H04B 7/0623

(57) ABSTRACT

Systems, methods, apparatuses, and computer program products for delivering multicell HARQ-ACK/NACK bits are provided. One embodiment is directed to a method that includes selecting, for example by a network node or user equipment, a physical uplink shared channel (PUSCH) transmission format. In one embodiment, the PUSCH transmission format may be selected based upon a total hybrid automatic repeat request (HARQ) payload size or network load situation. The selected physical uplink shared channel (PUSCH) transmission format may be one of a normal mode or an extended mode.

### BACKGROUND

1. Field

Embodiments of the invention generally relate to wireless or mobile communications networks, such as, but not limited to, the Universal Mobile Telecommunications System (UMTS) Terrestrial Radio Access Network (UTRAN), Long Term Evolution (LTE) Evolved UTRAN (E-UTRAN), LTE-Advanced (LTE-A), future 5G radio access technology, and/or High Speed Packet Access (HSPA). In particular, some embodiments may relate to the delivering of uplink control information.

2. Description of the Related Art

Universal Mobile Telecommunications System (UMTS) Terrestrial Radio Access Network (UTRAN) refers to a communications network including base stations, or Node Bs, and for example radio network controllers (RNC). UTRAN allows for connectivity between the user equipment (UE) and the core network. The RNC provides control functionalities for one or more Node Bs. The RNC and its corresponding Node Bs are called the Radio Network Subsystem (RNS). In case of E-UTRAN (enhanced UTRAN), no RNC exists and radio access functionality is provided in the enhanced Node B (eNodeB or eNB) or many eNBs. Multiple eNBs are involved for a single UE connection, for example, in case of Coordinated Multipoint Transmission (CoMP) and in dual connectivity.

Long Term Evolution (LTE) or E-UTRAN provides a new radio access technology and refers to the improvements of UMTS through improved efficiency and services, lower costs, and use of new spectrum opportunities. In particular, LTE is a 3GPP standard that provides for uplink peak rates of at least, for example, 75 megabits per second (Mbps) per carrier and downlink peak rates of at least, for example, 300 Mbps per carrier. LTE supports scalable carrier bandwidths from 20 MHz down to 1.4 MHz and supports both Frequency Division Duplexing (FDD) and Time Division Duplexing (TDD).

As mentioned above, LTE may also improve spectral efficiency in networks, allowing carriers to provide more data and voice services over a given bandwidth. Therefore, LTE is designed to fulfill the needs for high-speed data and media transport in addition to high-capacity voice support. Advantages of LTE include, for example, high throughput, low latency, FDD and TDD support in the same platform, an improved end-user experience, and a simple architecture resulting in low operating costs.

Certain releases of 3GPP LTE (for example, LTE Rel-10, LTE Rel-11, LTE Rel-12, LTE Rel-13) are targeted towards international mobile telecommunications advanced (IMT-A) systems, referred to herein for convenience simply as LTE-Advanced (LTE-A).

LTE-A is directed toward extending and optimizing the 3GPP LTE radio access technologies. A goal of LTE-A is to provide significantly enhanced services by means of higher data rates and lower latency with reduced cost. LTE-A is a more optimized radio system fulfilling the international telecommunication union-radio (ITU-R) requirements for IMT-Advanced while keeping the backward compatibility. One of the key features of LTE-A, introduced in LTE Rel-10, is carrier aggregation, which allows for increasing the data rates through aggregation of two or more LTE carriers, for example, to the transmission bandwidth of up to 100 MHz. LTE-A in later releases may include even wider bandwidths than specified so far. Further, aggregating or interworking on the radio access level with the wireless LAN (WLAN) access network is foreseen.

### SUMMARY

One embodiment is directed to a method that may include selecting a physical uplink shared channel (PUSCH) transmission format, where the selected physical uplink shared channel (PUSCH) transmission format is one of a normal mode or an extended mode.

Another embodiment is directed to an apparatus that may include at least one processor and at least one memory comprising computer program code. The at least one memory and the computer program code may be configured, with the at least one processor, to cause the apparatus at least to select a physical uplink shared channel (PUSCH) transmission format, where the selected physical uplink shared channel (PUSCH) transmission format is one of a normal mode or an extended mode.

Another embodiment may be directed to an apparatus that may include means for selecting a physical uplink shared channel (PUSCH) transmission format, where the selected physical uplink shared channel (PUSCH) transmission format is one of a normal mode or an extended mode.

Another embodiment is directed to a computer program, embodied on a non-transitory computer readable medium. The computer program may be configured to control a processor to perform a process that may include selecting a physical uplink shared channel (PUSCH) transmission format, where the selected physical uplink shared channel (PUSCH) transmission format is one of a normal mode or an extended mode.

### BRIEF DESCRIPTION OF THE DRAWINGS:

For proper understanding of the invention, reference should be made to the accompanying drawings, wherein:

FIG. 1 illustrates selection of the transmission mode for ACK/NACK-PUSCH using ARI bits, according to one embodiment;

FIG. 2 illustrates an example resource allocation for ACK/NACK-PUSCH and P-CSI-PUSCH, according to an embodiment;

FIG. 3 illustrates another example resource allocation option for ACK/NACK-PUSCH and P-CSI-PUSCH, according to an embodiment;

FIG. 4a illustrates an example block diagram of an apparatus, according to one embodiment;

FIG. 4b illustrates an example block diagram of an apparatus, according to another embodiment;

FIG. 5a illustrates an example flow diagram of a method, according to one embodiment; and

FIG. 5b illustrates an example flow diagram of a method, according to another embodiment.

### DETAILED DESCRIPTION:

It will be readily understood that the components of the invention, as generally described and illustrated in the figures herein, may be arranged and designed in a wide variety of different configurations. Thus, the following detailed description of embodiments of systems, methods, apparatuses, and computer program products for efficient resource allocation, as represented in the attached figures, is not intended to limit the scope of the invention, but is merely representative of some selected embodiments of the invention.

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments.

Additionally, if desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

Certain embodiments of the invention relate to LTE-Advanced (LTE-A) systems and, in particular, to 3GPP Release-13 and beyond. Specifically, certain embodiments provide enhanced methods and/or apparatuses for delivering multicell hybrid automatic repeat request (HARQ)-acknowledgement (ACK)/nonacknowledgement (NACK) bits along with other uplink control information, such as periodic channel state information (P-CSI), to the eNB when the number of configured and scheduled component carriers (CCs) in carrier aggregation (CA) exceed the current maximum, which is 5 CCs. A work item (WI) for an extended CA system, extending the number of CCs all the way up to 32 CCs, was accepted in 3GPP and is generally considered to be one of the main topics for Release-13.

When the number of serving cells increases, the number of HARQ bits and needed periodic CSI transmission occasions will also increase. Particularly, the increased number of HARQ payload bits easily becomes a bottleneck for CA performance, since the current physical uplink control channel (PUCCH) format 3, designed for CA deployments consisting of a maximum of five CCs, can carry a maximum of 21 HARQ-ACK/NACK bits. For TDD-only or TDD/FDD CA deployments, the number of HARQ-ACK/NACK bits may reach the maximum value of 318 bits if 16 CCs are assumed to be deployed. With spatial bundling that figure may be reduced to 159 bits, which is still well beyond the current maximum supported HARQ payload size. Even for FDD CA, the number of HARQ A/N bits sum up into 64 bits when all 32 CCs are assumed to be deployed. Likewise, the increased number of serving cells also calls for an increased number of periodic CSI reports to be transmitted to the eNB. Therefore, it has been proposed that more than one P-CSI report should be transmitted at one subframe in order to decrease the dropping rate of P-CSI reports.

A new PUCCH format requiring an extended set of physical resource block (PRB) resources in frequency has been proposed, as well as a method for sharing the same PRB resources among UEs using a new PUCCH format and UEs using legacy PUCCH formats. In addition, it has been proposed that physical uplink shared channel (PUSCH) transmission format could be used to convey extended HARQ-ACK/NACK payloads to an eNB. Likewise, it has been proposed that semi-persistently scheduled (SPS) PUSCH transmission could be used to convey a set of periodic CSI reports to an eNB in one subframe in the case when a large number of CCs are configured for a UE.

Embodiments of the present invention provide an efficient resource allocation method for ACK/NACK-PUSCH transmission, where the ACK/NACK-PUSCH transmission may assume either normal mode or an extended (bandwidth) mode. In addition, an efficient resource allocation method is provided for joint allocation of ACK/NACK-PUSCH and P-CSI-PUSCH transmissions.

According to an embodiment, when a number of HARQ-ACK/NACK bits in a subframe exceeds a pre-defined threshold, ACK/NACK bits are conveyed to an eNB using a PUSCH transmission format (hereafter referred to ACK/NACK-PUSCH). Alternatively, a UE may be configured by an eNB to transmit ACK/NACK bits using a PUSCH format. Depending upon total HARQ payload size and/or network or cell load situation, the PUSCH transmission mode may assume a normal mode that is comprised of 1 PRB allocation, or may assume an extended mode that is comprised of 2 PRBs allocation. Selection of ACK/NACK-PUSCH transmission mode may be made dynamically by the eNB using ACK/NACK Resource Index (ARI) bits along with the selection of resource index for PUSCH. According to one embodiment, one of the ARI bits are used for ACK/NACK-PUSCH mode selection while another bit is used to select one of the two ACK/NACK-PUSCH resources indexes configured for a UE using RRC-signaling. It should be noted that ACK/NACK-PUSCH transmission format is used for multi-cell ACK/NACK delivery only and thus it does not include any data symbols. This is in contrast to PUSCH with UCI transmission format which is comprised of both data symbols and uplink control information (UCI) symbols. Also, due to its dedication for ACK/NACK delivery, ACK/NACK-PUSCH transmission format may be called PUCCH format X for example in 3GPP. In an example embodiment, X=4 may be used. Naturally, also other terminology may be used.

It may be assumed that a set of P-CSI reports are transmitted in pre-defined subframes to eNB using PUSCH transmission format (hereafter referred to P-CSI-PUSCH) with SPS. It should be noted that PUSCH transmission format dedicated for P-CSI transmission may also be called PUCCH format X for example in 3GPP. One embodiment provides that, if ACK/NACK-PUSCH will take place in the same subframe as used for P-CSI-PUSCH transmission, ACK/NACK-PUSCH and P-CSI-PUSCH will be transmitted in one cluster (close to each other in frequency) in order to reduce peak-to-average power ratio (PARP) of UL transmission in subframes where no data PUSCH transmission is granted.

According to one embodiment, the ACK/NACK-PUSCH is located either one PRB above SPS-allocation of P-CSI-PUSCH or one PRB below SPS-allocation of P-CSI-PUSCH, where the selection may be made dynamically by the eNB using the ARI bits. Alternatively, P-CSI-PUSCH may be relocated next to ACK/NACK-PUSCH in a pre-defined way. Also, fallback mode may be indicated using ARI bits. Thus, according to certain embodiments, the ARI bits are interpreted in different ways depending, for example, on whether ACK/NACK-PUSCH and P-CSI-PUSCH are transmitted in the same subframe or not.

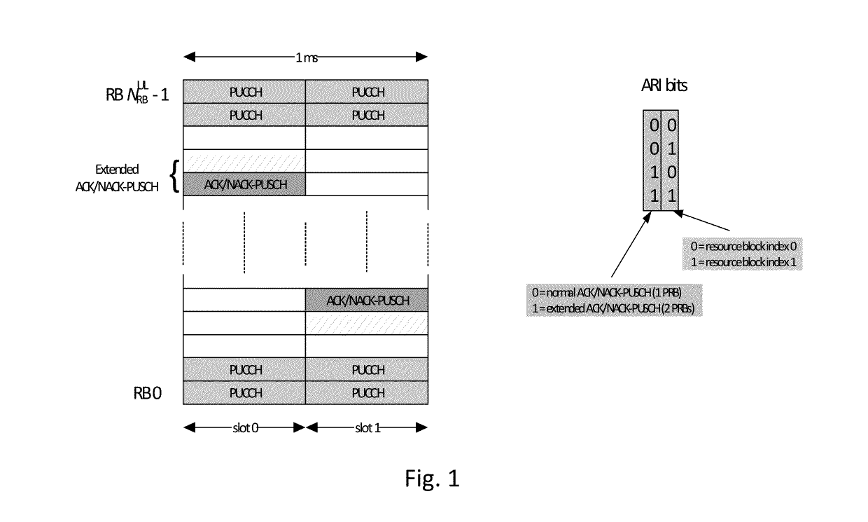

In the following, some example embodiments are presented using some figures to illustrate certain cases. FIG. 1 illustrates selection of the transmission mode for ACK/NACK-PUSCH using ARI bits, according to one embodiment. In particular, FIG. 1 illustrates an example embodiment for selecting the transmission mode and PRB allocation for ACK/NACK-PUSCH in cases where P-CSI-PUSCH is not transmitted in the same subframe. In this example, the decision whether a normal or extended transmission mode is used for ACK/NACK-PUSCH is up to the eNB, which may base its decision on various factors such as the amount of HARQ payload of a UE and/or the amount of other UEs that the cell has to support at that moment (namely, the amount of traffic in the cell). An extended ACK/NACK-PUSCH mode may be used, for example, when HARQ payload size is high, the network is not fully loaded, and the UE is not coverage-limited (namely, the UE has enough power to transmit with an extended bandwidth). Otherwise, if the HARQ payload size is higher than what normally could be supported by 1 PRB allocation, then HARQ bundling over different CCs and/or decreasing the coding rate may be used as methods to fit the HARQ payload size to the normal ACK/NACK-PUSCH transmission format. It is noted that frequency hopping is assumed for ACK/NACK-PUSCH within a subfame in the example of FIG. 1.

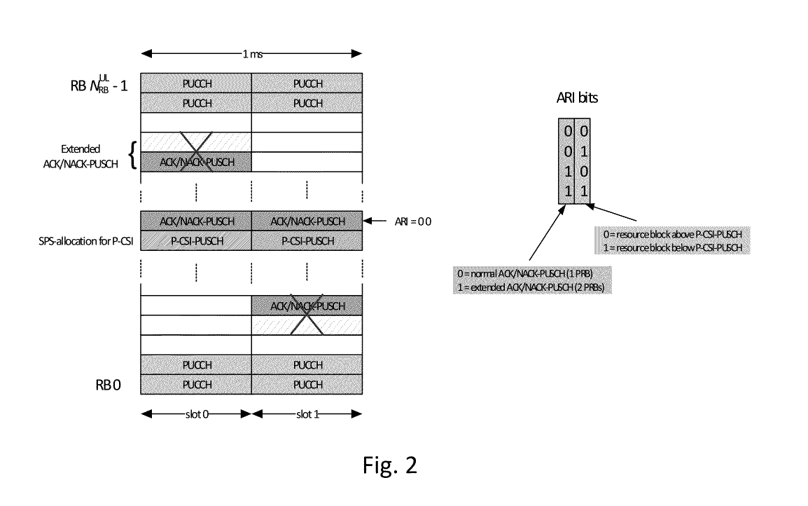

Next, two example embodiments are given for cases where ACK/NACK-PUSCH and P-CSI-PUSCH are transmitted in the same subframe. FIG. 2 illustrates an example resource allocation for ACK/NACK-PUSCH and P-CSI-PUSCH. In the example of FIG. 2, frequency allocation for P-CSI-PUSCH is used as an anchor allocation such that ACK/NACK-PUSCH is relocated next to P-CSI-PUSCH allocation, either above or below depending upon ARI signaling. In the embodiment of FIG. 2, the assignment of ARI=(0 0) means that the first ARI bit indicates normal transmission mode for ACK/NACK-PUSCH (namely, only one PRB reserved for ACK/NACK-PUSCH) and the second ARI bit indicates that the ACK/NACK-PUSCH is located above the pre-determined P-CSI-PUSCH allocation. The capability to locate ACK/NACK-PUSCH either above or below P-CSI-PUSCH gives some degree of scheduling flexibility to eNB.

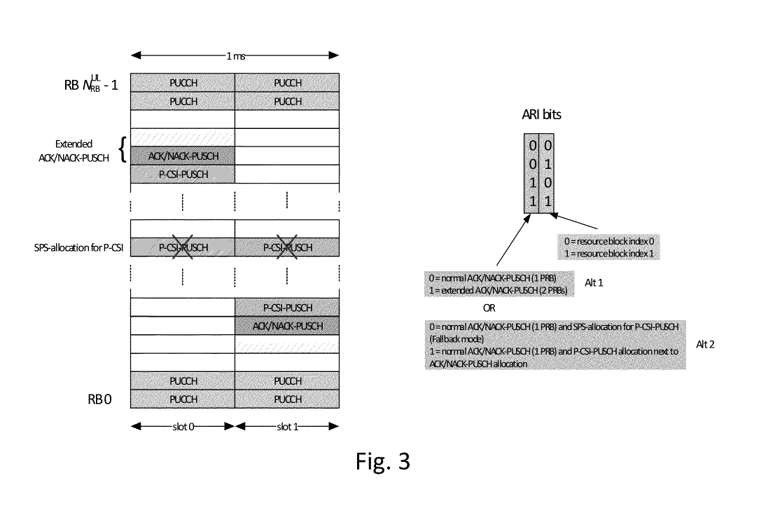

FIG. 3 illustrates another example resource allocation option for ACK/NACK-PUSCH and P-CSI-PUSCH. In this example, P-CSI-PUSCH is relocated next to the selected ACK/NACK-PUSCH allocation position. The crosses “X” in FIGS. 2 and 3 show the location of ACK/NACK-PUSCH and P-CSI-PUSCH, respectively, in the case where these two types of PUSCH transmissions do not happen to coincide in the same subframe (namely, their default location if transmitted as a single signal). In FIG. 3, two alternative interpretation of ARI bits are given such that Alt 2 provides a fallback mode where P-CSI-PUSCH is transmitted in a semi-statically configured PRB while the allocation for ACK/NACK-PUSCH is selected using ARI signaling (like in the absence of P-CSI-PUSCH). In Alt 1, ARI bits are used to select a transmission mode and location for ACK/NACK-PUSCH in a similar way as if transmitted alone and P-CSI-PUSCH is re-located next to ACK/NACK-PUSCH in a pre-determined way. It should be understood, however, that there are naturally many other possibilities, in addition to the examples herein, to use ARI bits: 1) to select the transmission mode for ACK/NACK-PUSCH, and 2) to arrange the frequency allocation locations for ACK/NACK-PUSCH and P-CSI-PUSCH such that one cluster transmission may be obtained.

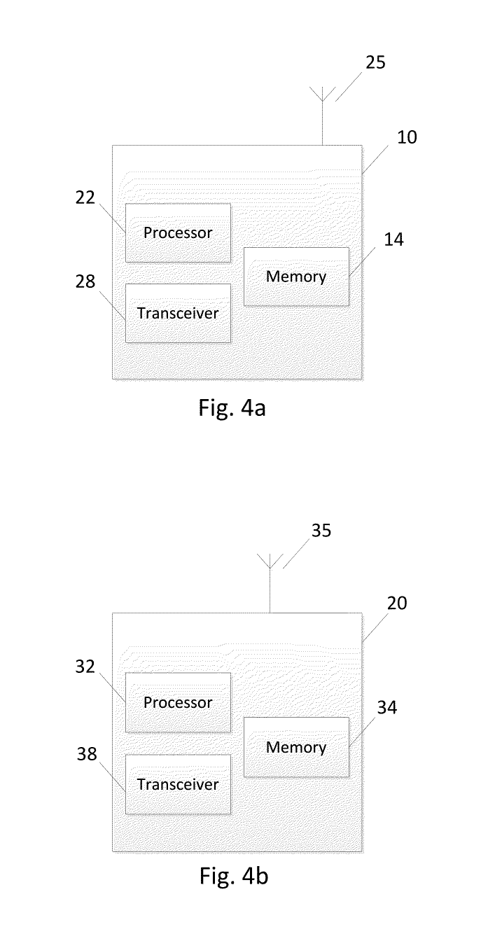

FIG. 4a illustrates an example of an apparatus 10 according to an embodiment. In an embodiment, apparatus 10 may be a node, host, or server in a communications network or serving such a network. For example, in certain embodiments, apparatus 10 may be a network node or access node for a radio access network, such as a base station in UMTS or eNB in LTE or LTE-A. However, in other embodiments, apparatus 10 may be other components within a radio access network. It should be noted that one of ordinary skill in the art would understand that apparatus 10 may include components or features not shown in FIG. 4a.

As illustrated in FIG. 4a, apparatus 10 includes a processor 22 for processing information and executing instructions or operations. Processor 22 may be any type of general or specific purpose processor. While a single processor 22 is shown in FIG. 4a, multiple processors may be utilized according to other embodiments. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 may further include or be coupled to a memory 14 (internal or external), which may be coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 may be comprised of any combination of random access memory (RAM), read only memory (ROM), static storage such as a magnetic or optical disk, or any other type of non-transitory machine or computer readable media. The instructions stored in memory 14 may include program instructions or computer program code that, when executed by processor 22, enable the apparatus 10 to perform tasks as described herein.

In some embodiments, apparatus 10 may also include or be coupled to one or more antennas 25 for transmitting and receiving signals and/or data to and from apparatus 10. Apparatus 10 may further include or be coupled to a transceiver 28 configured to transmit and receive information. For instance, transceiver 28 may be configured to modulate information on to a carrier waveform for transmission by the antenna(s) 25 and demodulate information received via the antenna(s) 25 for further processing by other elements of apparatus 10. In other embodiments, transceiver 28 may be capable of transmitting and receiving signals or data directly.

Processor 22 may perform functions associated with the operation of apparatus 10 which may include, for example, precoding of antenna gain/phase parameters, encoding and decoding of individual bits forming a communication message, formatting of information, and overall control of the apparatus 10, including processes related to management of communication resources.

In an embodiment, memory 14 may store software modules that provide functionality when executed by processor 22. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

As mentioned above, in one embodiment, apparatus 10 may be a network node or access node, such as a base station in UMTS or an eNB in LTE or LTE-A, for example. According to an embodiment, apparatus 10 may be controlled by memory 14 and processor 22 to select a physical uplink shared channel (PUSCH) transmission format based upon a total hybrid automatic repeat request (HARQ) payload size or network load situation. The selected physical uplink shared channel (PUSCH) transmission format is one of a normal mode or an extended mode. In some embodiments, the normal mode may comprise 1 PRB allocation, and the extended mode may comprise 2 PRBs allocation.

In certain embodiments, apparatus 10 may also be controlled by memory 14 and processor 22 to configure a UE to transmit ACK/NACK bits using the PUSCH transmission format, and to receive the ACK/NACK bits from the UE using the PUSCH transmission format when a number of HARQ ACK/NACK bits in a subframe exceeds a pre-defined threshold. According to one embodiment, apparatus 10 may also be controlled by memory 14 and processor 22 to dynamically select the PUSCH transmission format using ARI bits along with selection of resource index for the PUSCH.

In one embodiment, one of the ARI bits is used for selection of the PUSCH transmission format, and another one of the ARI bits is used to select one of the two ACK/NACK-PUSCH resource indexes configured for a UE using RRC signaling. According to an embodiment, when ACK/NACK-PUSCH will take place in same subframe as used for P-CSI PUSCH transmission, ACK/NACK-PUSCH and P-CSI-PUSCH will be transmitted in one cluster in order to reduce peak-to-average power ratio (PARP) of uplink (UL) transmission in subframes where no data PUSCH transmission is granted.

In one embodiment, apparatus 10 may be further controlled by memory 14 and processor 22 to dynamically select, using ARI bits, whether the ACK/NACK-PUSCH is located one PRB above semi-persistently scheduled (SPS) allocation of P-CSI PUSCH or one PRB below SPS allocation of P-CSI-PUSCH.

FIG. 4b illustrates an example of an apparatus 20 according to another embodiment. In an embodiment, apparatus 20 may be a node or element in a communications network or associated with such a network, such as a UE, mobile device, mobile unit, a machine type UE or other device. For instance, in some embodiments, apparatus 20 may be UE in LTE or LTE-A. It should be noted that one of ordinary skill in the art would understand that apparatus 20 may include components or features not shown in FIG. 4b.

As illustrated in FIG. 4b, apparatus 20 includes a processor 32 for processing information and executing instructions or operations. Processor 32 may be any type of general or specific purpose processor. While a single processor 32 is shown in FIG. 4b, multiple processors may be utilized according to other embodiments. In fact, processor 32 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 20 may further include or be coupled to a memory 34 (internal or external), which may be coupled to processor 32, for storing information and instructions that may be executed by processor 32. Memory 34 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 34 may be comprised of any combination of random access memory (RAM), read only memory (ROM), static storage such as a magnetic or optical disk, or any other type of non-transitory machine or computer readable media. The instructions stored in memory 34 may include program instructions or computer program code that, when executed by processor 32, enable the apparatus 20 to perform tasks as described herein.

In some embodiments, apparatus 20 may also include or be coupled to one or more antennas 35 for transmitting and receiving signals and/or data to and from apparatus 20. Apparatus 20 may further include a transceiver 38 configured to transmit and receive information. For instance, transceiver 38 may be configured to modulate information on to a carrier waveform for transmission by the antenna(s) 35 and demodulate information received via the antenna(s) 35 for further processing by other elements of apparatus 20. In other embodiments, transceiver 38 may be capable of transmitting and receiving signals or data directly.

Processor 32 may perform functions associated with the operation of apparatus 20 including, without limitation, precoding of antenna gain/phase parameters, encoding and decoding of individual bits forming a communication message, formatting of information, and overall control of the apparatus 20, including processes related to management of communication resources.

In an embodiment, memory 34 stores software modules that provide functionality when executed by processor 32. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

As mentioned above, according to one embodiment, apparatus 20 may be a mobile device, such as a UE in LTE or LTE-A. In this embodiment, apparatus 20 may be controlled by memory 34 and processor 32 to, when a number of HARQ-ACK/NACK bits in a subframe exceeds a pre-defined threshold, convey ACK/NACK bits to an eNB using a PUSCH transmission format (namely, ACK/NACK-PUSCH). Apparatus 20 may be configured by the eNB to transmit ACK/NACK bits using a PUSCH format. In certain embodiments, depending on the total HARQ payload size and/or network or cell load situation, the PUSCH transmission format used by apparatus 20 may assume a normal mode comprised of 1 PRB allocation, or an extended mode comprised of 2 PRBs allocation.

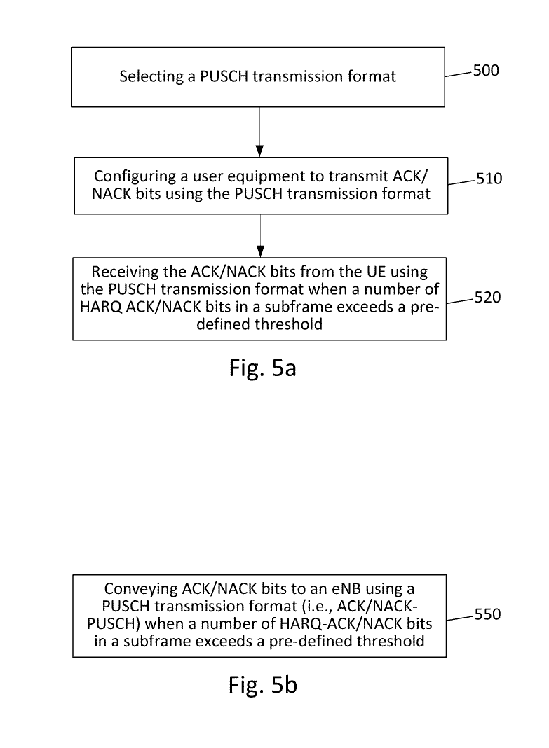

FIG. 5a illustrates an example flow diagram of a method for delivering multi-cell HARQ-ACK/NACK bits, according to an embodiment of the invention. In one example, the method of FIG. 5a may be performed by one or more nodes in or associated with a network. The method may include, at 500, selecting a PUSCH transmission format based upon a total HARQ payload size and/or network load situation. The selected physical uplink shared channel (PUSCH) transmission format may be one of a normal mode or an extended mode. The normal mode may be comprised of 1 PRB allocation, and the extended mode may be comprised of 2 PRBs allocation.

In certain embodiments, the method may also include, at 510, configuring a user equipment to transmit ACK/NACK bits using the PUSCH transmission format. At 520, the method may include receiving the ACK/NACK bits from the UE using the PUSCH transmission format when a number of HARQ ACK/NACK bits in a subframe exceeds a pre-defined threshold.

According to some embodiments, the selecting of PUSCH transmission format may include dynamically selecting the PUSCH transmission format using ARI bits along with selection of resource index for the PUSCH. For example, one of the ARI bits is used for selection of the PUSCH transmission format, and another one of the ARI bits is used to select one of the two ACK/NACK PUSCH resource indexes configured for a UE using RRC signaling.

In one embodiment, the method may also include dynamically selecting, using ARI bits, whether the ACK/NACK PUSCH is located one PRB above SPS allocation of P-CSI PUSCH or one PRB below SPS allocation of P-CSI-PUSCH.

FIG. 5b illustrates an example flow diagram of a method for delivering multi-cell HARQ-ACK/NACK bits, according to an embodiment of the invention. In one example, the method of FIG. 5b may be performed by a UE. As illustrated in FIG. 5b, the method may include, at 550, conveying ACK/NACK bits to an eNB using a PUSCH transmission format (namely, ACK/NACK-PUSCH) when a number of HARQ-ACK/NACK bits in a subframe exceeds a pre-defined threshold. The UE may be configured by the eNB to transmit ACK/NACK bits using a PUSCH format. In certain embodiments, depending on the total HARQ payload size and/or network or cell load situation, the PUSCH transmission format used by the UE may assume a normal mode comprised of 1 PRB allocation, or an extended mode comprised of 2 PRBs allocation. Before conveying the ACK/NACK bits, the UE may receive configuration information from the eNB. In an example embodiment, the UE may be configured with a set of resource indexes for ACK/NACK-PUSCH transmission and/or resource index for P-CSI-PUSCH transmission.

Embodiments of the invention may provide several advantages and/or technical improvements. For example, two bandwidth options for ACK/NACK-PUSCH and dynamic selection for these options provides eNB with flexibility in making proper tradeoffs between ACK/NACK detection probability and the overall overhead caused by ACK/NACK feedback signaling. Transmission of ACK/NACK-PUSCH and P-CSI-PUSCH in one cluster provides the benefit of reduced PARP at the UE side, thus improving the coverage of a UE and decreasing interband interference within a cell. There may also be a fallback mode such that this possibility is used only in situations where it gives clear benefits.

Programs, also called program products or computer programs, including software routines, applets and macros, may be stored in any apparatus-readable data storage medium and they include program instructions to perform particular tasks. A computer program product may comprise one or more computer-executable components which, when the program is run, are configured to carry out embodiments. The one or more computer-executable components may be at least one software code or portions of it. Modifications and configurations required for implementing functionality of an embodiment may be performed as routine(s), which may be implemented as added or updated software routine(s). Software routine(s) may be downloaded into the apparatus.

Software or a computer program code or portions of it may be in a source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other embodiments, the functionality of any method or apparatus described herein may be performed by hardware, for example through the use of an application specific integrated circuit (ASIC), a programmable gate array (PGA), a field programmable gate array (FPGA), or any other combination of hardware and software. In yet another embodiment, the functionality may be implemented as a signal, a non-tangible means that may be carried by an electromagnetic signal downloaded from the Internet or other network.

According to an embodiment, an apparatus, such as a node, device, or a corresponding component, may be configured as a computer or a microprocessor, such as single-chip computer element, or as a chipset, including at least a memory for providing storage capacity used for arithmetic operation and an operation processor for executing the arithmetic operation.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method, comprising:
selecting a physical uplink shared channel (PUSCH) transmission format,
wherein the selected physical uplink shared channel (PUSCH) transmission format is one of a normal mode or an extended mode.

2. The method according to claim 1, wherein the physical uplink shared channel (PUSCH) transmission format is used when a number of hybrid automatic repeat request (HARQ) acknowledgement/non-acknowledgement (ACK/NACK) bits in a subframe exceeds a pre-defined threshold.

3. The method according to claim 1, wherein the selecting is based upon a total hybrid automatic repeat request (HARQ) payload size or network load situation.

4. The method according to claim 1, further comprising:
configuring a user equipment to transmit acknowledgement/non-acknowledgement (ACK/NACK) bits using the physical uplink shared channel (PUSCH) transmission format; and
receiving the acknowledgement/non-acknowledgement (ACK/NACK) bits from the user equipment using the physical uplink shared channel (PUSCH) transmission format.

5. The method according to claim 1, wherein the normal mode comprises 1 physical resource block (PRB) allocation, and wherein the extended mode comprises 2 physical resource blocks (PRBs) allocation.

6. The method according to claim 1, wherein the selecting further comprises dynamically selecting the physical uplink shared channel (PUSCH) transmission format using acknowledgement/non-acknowledgement (ACK/NACK) resource index (ARI) bits along with selection of resource index for the physical uplink shared channel (PUSCH).

7. The method according to claim 4, wherein one of the acknowledgement/non-acknowledgement (ACK/NACK) resource index (ARI) bits is used for selection of the physical uplink shared channel (PUSCH) transmission format, and another one of the acknowledgement/non-acknowledgement (ACK/NACK) resource index (ARI) bits is used to select one of the two acknowledgement/non-acknowledgement (ACK/NACK) physical uplink shared channel (PUSCH) resource indexes configured for a user equipment using radio resource control (RRC) signaling.

8. The method according to claim 1, when acknowledgement/non-acknowledgement (ACK/NACK) physical uplink shared channel (PUSCH) will take place in same subframe as used for periodic channel state information (P-CSI) PUSCH transmission, ACK/NACK-PUSCH and P-CSI-PUSCH will be transmitted in one cluster in order to reduce peak-to-average power ratio (PARP) of uplink (UL) transmission in subframes where no data PUSCH transmission is granted.

9. The method according to claim 8, further comprising dynamically selecting by the network node, using acknowledgement/non-acknowledgement (ACK/NACK) resource index (ARI) bits, whether the acknowledgement/non-acknowledgement (ACK/NACK) physical uplink shared channel (PUSCH) is located one physical resource block (PRB) above semi-persistently scheduled (SPS) allocation of periodic channel state information (P-CSI) PUSCH or one physical resource block (PRB) below SPS allocation of P-CSI-PUSCH.

10. An apparatus, comprising:
at least one processor; and
at least one memory comprising computer program code,
the at least one memory and the computer program code are configured, with the at least one processor, to cause the apparatus at least to
select a physical uplink shared channel (PUSCH) transmission format,
wherein the selected physical uplink shared channel (PUSCH) transmission format is one of a normal mode or an extended mode.

11. The apparatus according to claim 10, wherein the physical uplink shared channel (PUSCH) transmission format is used when a number of hybrid automatic repeat request (HARQ) acknowledgement/non-acknowledgement (ACK/NACK) bits in a subframe exceeds a pre-defined threshold.

12. The apparatus according to claim 10, wherein the selection of the physical uplink shared channel (PUSCH) transmission format is based upon a total hybrid automatic repeat request (HARQ) payload size or network load situation.

13. The apparatus according to claim 10, wherein the at least one memory and the computer program code are further configured, with the at least one processor, to cause the apparatus at least to:
configure a user equipment to transmit acknowledgement/non-acknowledgement (ACK/NACK) bits using the physical uplink shared channel (PUSCH) transmission format; and
receive the acknowledgement/non-acknowledgement (ACK/NACK) bits from the user equipment using the physical uplink shared channel (PUSCH) transmission format.

14. The apparatus according to claim 10, wherein the normal mode comprises 1 physical resource block (PRB) allocation, and wherein the extended mode comprises 2 physical resource blocks (PRBs) allocation.

15. The apparatus according to claim 10, wherein the at least one memory and the computer program code are further configured, with the at least one processor, to cause the apparatus at least to dynamically select the physical uplink shared channel (PUSCH) transmission format using acknowledgement/non-acknowledgement (ACK/NACK) resource index (ARI) bits along with selection of resource index for the physical uplink shared channel (PUSCH).

16. The apparatus according to claim 15, wherein one of the acknowledgement/non-acknowledgement (ACK/NACK) resource index (ARI) bits is used for selection of the physical uplink shared channel (PUSCH) transmission format, and another one of the acknowledgement/non-acknowledgement (ACK/NACK) resource index (ARI) bits is used to select one of the two acknowledgement/non-acknowledgement (ACK/NACK) physical uplink shared channel (PUSCH) resource indexes configured for a user equipment using radio resource control (RRC) signaling.

17. The apparatus according to claim 10, when acknowledgement/non-acknowledgement (ACK/NACK) physical uplink shared channel (PUSCH) will take place in same subframe as used for periodic channel state information (P-CSI) PUSCH transmission, ACK/NACK-PUSCH and P-CSI-PUSCH will be transmitted in one cluster in order to reduce peak-to-average power ratio (PARP) of uplink (UL) transmission in subframes where no data PUSCH transmission is granted.

18. The apparatus according to claim 17, wherein the at least one memory and the computer program code are further configured, with the at least one processor, to cause the apparatus at least to dynamically select, using acknowledgement/non-acknowledgement (ACK/NACK) resource index (ARI) bits, whether the acknowledgement/non-acknowledgement (ACK/NACK) physical uplink shared channel (PUSCH) is located one physical resource block (PRB) above semi-persistently scheduled (SPS) allocation of periodic channel state information (P-CSI) PUSCH or one physical resource block (PRB) below SPS allocation of P-CSI-PUSCH.

19. The apparatus according to claim 10, wherein the apparatus comprises an evolved node B (eNB) or a user equipment.

20. A computer program, embodied on a non-transitory computer readable medium, the computer program configured to control a processor to perform a process, comprising:
selecting a physical uplink shared channel (PUSCH) transmission format,
wherein the selected physical uplink shared channel (PUSCH) transmission format is one of a normal mode or an extended mode.
